(19) United States
(12) Patent Application Publication
(10) Pub. No.: US 2026/0233389 A1
(43) Pub. Date: Aug. 13, 2026

(54) ROBOT SYSTEM, CONTROL DEVICE, ROBOT, AND CONTROL METHOD

(71) Applicant: HITACHI, LTD., Tokyo (JP)

(72) Inventors: Yoshiki KANAI, Tokyo (JP); Hiroshi ITO, Tokyo (JP)

(21) Appl. No.: 19/531,075

(22) Filed: Feb. 5, 2026

(30) Foreign Application Priority Data
Feb. 7, 2025 (JP) 2025-019406

(51) Int. Cl. B25J 9/16

(52) U.S. Cl. CPC B25J 9/163; B25J 9/1661

(57) ABSTRACT

Provided are: an operation unit that outputs operation information for operating a task execution robot that autonomously executes a task according to predicted state information based on a trained model ; a control unit that controls the task execution robot, and a learning unit that performs learning based on the state information of the task execution robot and/or the operation information to generate a trained model, in which the control unit includes a task execution robot command information generation unit that generates task execution robot command information, which is command information for the task execution robot, based on the state information, the operation information, and the predicted state information, and the learning unit collects the state information output from the task execution robot command information generation unit and/or the operation information as retraining data, performs learning using the retraining data to perform relearning with respect to the trained model.

### CROSS-REFERENCE TO RELATED APPLICATION

The present application claims the benefit of priority to Japanese Patent Application No. 2025-019406 filed on February 7, 2025, the disclosures of all of which are hereby incorporated by reference in their entireties.

### BACKGROUND OF THE INVENTION

### 1. Field of the Invention

The present invention relates to techniques of a robot system, a control device, a robot, and a control method.

### 2. Description of the Related Art

A technique for causing a robot to autonomously operate based on a learning result of machine learning has been proposed. As such a technique, there is disclosed a technique described in Jianlan Luo, Perry Dong, Yuexiang Zhai, Yi Ma, and Sergey Levine, “RLIF: INTERACTIVE IMITATION LEARNING AS REINFORCEMENT LEARNING”, The 12th International Conference on Learning Representations (ICLR2024), 2024.

Jianlan Luo, Perry Dong, Yuexiang Zhai, Yi Ma, and Sergey Levine, “RLIF: INTERACTIVE IMITATION LEARNING AS REINFORCEMENT LEARNING”, The 12th International Conference on Learning Representations (ICLR2024), 2024 discloses that, when an autonomously operating robot performs an undesirable operation, a user operates the robot to correct the operation, and robot operation data at that time is newly accumulated as retraining data.

### SUMMARY OF THE INVENTION

In the technique of Jianlan Luo, Perry Dong, Yuexiang Zhai, Yi Ma, and Sergey Levine, “RLIF: INTERACTIVE IMITATION LEARNING AS REINFORCEMENT LEARNING”, The 12th International Conference on Learning Representations (ICLR2024), 2024, and the like, the user observes the autonomous operation of the robot and temporarily stops the robot when the robot performs the undesirable operation, and the user operates the robot, whereby the retraining data is acquired.

At that time, the user manually operates the robot to perform a desired operation, and collects data for the retraining data. However, completing a task by manual operation is difficult for a beginner, and is not efficient, either.

The present invention has been made in view of such a background, and provides a robot system, a control device, a robot, and a control method capable of efficiently acquiring data for relearning.

In order to solve the above problem, the present invention provides a robot system including: a task execution robot configured to autonomously execute a task according to predicted state information based on a trained model; a state information acquisition processing unit configured to acquire state information of the task execution robot; an operation unit configured to output operation information for causing the task execution robot to operate; a control unit configured to control the task execution robot; and a learning unit configured to perform learning based on the state information of the task execution robot and/or the operation information to generate the trained model, wherein the control unit includes a task execution robot command information generation unit configured to generate task execution robot command information, which is command information for the task execution robot, based on the state information, the operation information, and the predicted state information, and the learning unit collects the state information of the task execution robot and/or the operation information output from the task execution robot command information generation unit as retraining data, and performs relearning with respect to the trained model using the retraining data.

Other solutions will be described as appropriate in embodiments.

According to the present invention, it is possible to provide the robot system, the control device, the robot, and the control method capable of efficiently acquiring the retraining data.

### BRIEF DESCRIPTION OF THE DRAWINGS

FIG. 1 is a diagram illustrating a configuration of a robot system according to a first embodiment;

FIG. 2 is a diagram illustrating operations of a task execution robot command information generation unit and an operation unit command information generation unit;

FIG. 3 is a diagram illustrating the operation of the task execution robot command information generation unit in detail;

FIG. 4 is a flowchart illustrating a procedure of a control method of the robot system according to the first embodiment;

FIG. 5 is a view illustrating a method of operation detection by a user;

FIG. 6 is a diagram illustrating control switching accompanying the operation detection by the user;

FIG. 7 is a flowchart illustrating a procedure of a control method of a robot system according to a second embodiment;

FIG. 8 is a view related to state information collected as retraining data;

FIG. 9 is a diagram related to weighting of training data and retraining data;

FIG. 10 is a diagram illustrating a configuration of a robot system according to a modification; and

FIG. 11 is a diagram illustrating a hardware configuration of a computer.

### DESCRIPTION OF THE PREFERRED EMBODIMENTS

Next, modes for carrying out the present invention (referred to as “embodiments”) will be described in detail with reference to the drawings as appropriate.

Similar configurations in each of the drawings will be denoted by the same reference signs, and the description thereof will be omitted.

### First Embodiment

### Robot System Z

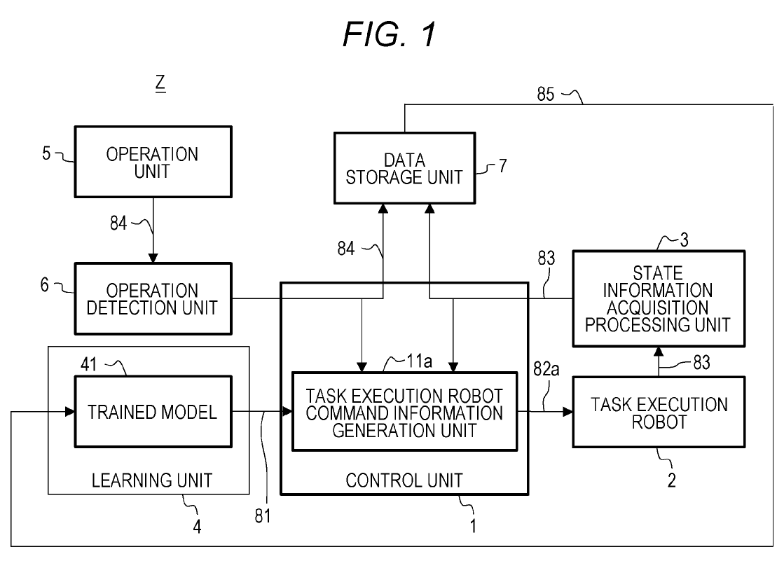

FIG. 1 is a diagram illustrating a configuration of a robot system Z according to a first embodiment.

The robot system Z includes a control unit 1, a task execution robot 2, a state information acquisition processing unit 3, a learning unit 4, an operation unit 5, an operation detection unit 6, and a data storage unit 7. The control unit 1 also includes a task execution robot command information generation unit 11a.

The task execution robot 2 autonomously executes a task according to predicted state information 81 based on a trained model 41. The state information acquisition processing unit 3 acquires state information 83 of the task execution robot 2. The operation unit 5 outputs operation information 84 for operating the task execution robot 2. When a user operates the operation unit 5, the operation unit 5 outputs the operation information 84. Then, the operation detection unit 6 detects that operation unit 5 has been operated, and outputs operation information 84. The operation information 84 is output via the operation detection unit 6, but is described as being output from the operation unit 5 as appropriate.

The control unit 1 controls the task execution robot 2. The control unit 1 includes the task execution robot command information generation unit 11a that generates task execution robot command information 82a, which is command information 82 (see FIG. 3) for the task execution robot 2, based on the state information 83, the operation information 84, and the predicted state information 81.

The learning unit 4 performs learning based on the state information 83 of the task execution robot 2 and/or the operation information 84 to generate the trained model 41. Specifically, the learning unit 4 collects the state information 83 of the task execution robot 2 and/or the operation information 84 output from the task execution robot command information generation unit 11a as retraining data 85. Then, the learning unit 4 performs relearning with respect to the trained model 41 using the retraining data 85. As a result, the trained model 41 is updated to one reflecting the content of the retraining data 85.

The trained model 41 is an operation model of the task execution robot 2 on which learning has been performed in advance. For the learning, a neural network or the like capable of learning an operation of the task execution robot 2 is used.

The data storage unit 7 stores the state information 83 output from the state information acquisition processing unit 3 and the operation information 84 output from the operation detection unit 8, and transfers the stored state information 83 and/or operation information 84 to the learning unit 4 as the retraining data 85.

Note that the learning unit 4 and the data storage unit 7 are included in the robot system Z in FIG. 1, but are not necessarily included in the robot system Z.

In the present embodiment, in a case where the user determines that the task execution robot 2 is likely to fail a task, the user operates the task execution robot 2 via the operation unit 5 to correct the operation of the task execution robot 2.

### Control of Task Execution Robot 2 and Operation Unit 5

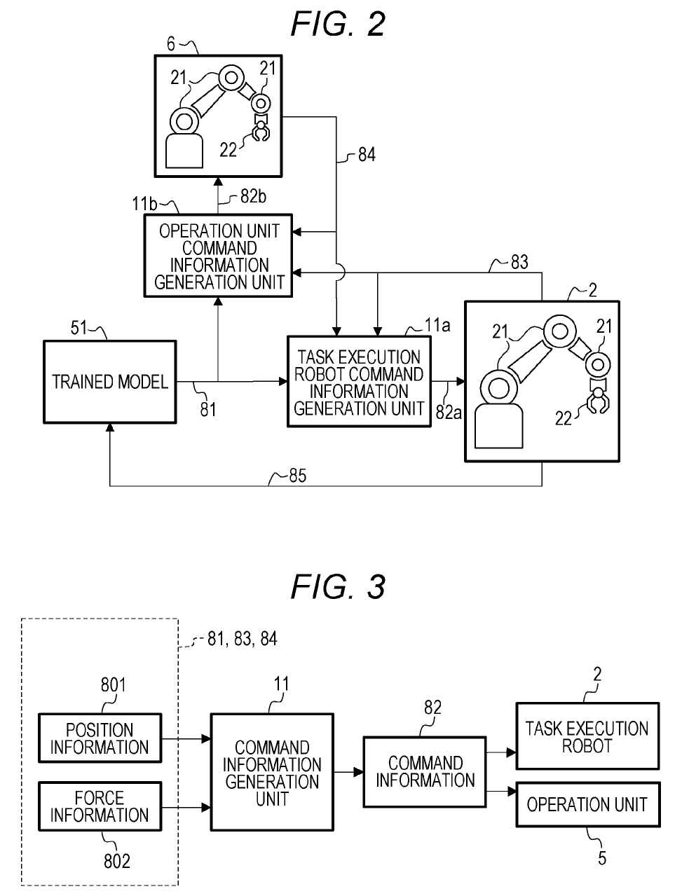

FIG. 2 is a diagram illustrating operations of the task execution robot command information generation unit 11a and an operation unit command information generation unit 11b.

In the example illustrated in FIG. 2, the operation unit 5 is a robot having a structure similar to that of the task execution robot 2. That is, the operation unit 5 is a robot having actuators 21 as many as those of the task execution robot 2. Similarly to the task execution robot 2, the operation unit 5 includes an end effector 22 which is a “predetermined portion”.

The operation information 84 output from the operation unit 5 is information including the same type of state quantity as a state quantity included in the state information 83. As will be described later, the state quantity is a position of the predetermined portion of the task execution robot 2 and/or each of the actuators 21, a force applied to the predetermined portion and/or each of the actuators 21, or the like. Further, “including the same type of state quantity” means that both the state information 83 and the operation information 84 include position and force information.

In addition to the task execution robot command information generation unit 11a, the robot system Z illustrated in FIG. 1 includes the operation unit command information generation unit 11b that generates operation unit command information 82b, which is the command information 82 (see FIG. 3) for the operation unit 5, based on the state information 83, the operation information 84, and the predicted state information 81. The state quantity includes the positions of the end effector 22, which is the predetermined portion, and the actuators 21 and the forces applied to the end effector 22 and the actuators 21.

Based on the predicted state information 81 obtained by the trained model 41, the task execution robot command information generation unit 11a generates the task execution robot command information 82a in which command values for the task execution robot 2 are stored. In a case where the task execution robot 2 and the operation unit 5 are robots having similar structures, the task execution robot command information 82a and the operation unit command information 82b are similar. However, since there is an individual difference between the robot used in the task execution robot 2 and the robot used in the operation unit 5, the task execution robot command information 82a and the operation unit command information 82b are not completely the same. Incidentally, torque in the actuator 21 and the like are stored as the command values in the task execution robot command information 82a and the operation unit command information 82b.

When the task execution robot 2 operates, the state information 83 of the task execution robot 2 based on such an operation is acquired and output by the state information acquisition processing unit 3 illustrated in FIG. 1. The output state information 83 is input (fed back) to the task execution robot command information generation unit 11a and the operation unit command information generation unit 11b. The task execution robot command information generation unit 11a generates a command value by the trained model 41 using the input state information 83, and generates the task execution robot command information 82a in the next step. Similarly, the operation unit command information generation unit 11b generates a command value by the trained model 41 using the input state information 83, and generates the operation unit command information 82b in the next step. Thus, the operation by the operation unit 5 is reflected in the operation of the task execution robot 2.

As the above processing is performed, the task execution robot 2 and the operation unit 5 perform similar operations.

When the state information 83 based on the operation of the task execution robot 2 is input to the operation unit command information generation unit 11b, the user can feel a reaction force generated in the task execution robot 2 when the user operates the operation unit 5.

Then, when an operation of the task execution robot 2 fails or is predicted to fail, the user operates the operation unit 5 to correct the operation. The operation information 84 output when the user operates the operation unit 5 is input to the operation unit command information generation unit 11b and input to the task execution robot command information generation unit 11a.

For example, it is assumed that a task of the task execution robot 2 is to insert a rectangular object into a pit opened on a floor. At this time, it is assumed that there occurs an operation failure in which the task execution robot 2 tries to insert the object in front of the pit. At this time, the user operates the operation unit 5 such that the end effector 22 of the task execution robot 2 moves backward. As a result, the task execution robot 2 can insert the object. As described above, the user can feel the reaction force applied to the task execution robot 2 (according to the above example, a reaction force of the floor acting on the task execution robot 2 via the object) via the operation unit 5.

The operation information 84 output when the user operates the operation unit 5 and/or the state information 83 in the task execution robot 2 is stored in the data storage unit 7 as the retraining data 85. The relearning with respect to the trained model 41 is performed based on the operation information 84 and/or the state information 83 stored in the retraining data 85.

As described above, the operation information 84 is information including the same type of state quantity as the state quantity included in the state information 83. Then, the operation unit command information generation unit 11b generates the operation unit command information 82b, which is the command information 82 (see FIG. 3) for the operation unit 5, based on the state information 83, the operation information 84, and the predicted state information 81. Further, the operation unit 5 includes the actuators 21 as many as those of the task execution robot 2. In this manner, the operation unit 5 performs an operation similar to that of the task execution robot 2. Thus, the user can recognize an operation of the task execution robot 2 and easily recognize how to correct the operation.

### Task Execution Robot Command Information Generation Unit 11a

FIG. 3 is a diagram illustrating the operation of the task execution robot command information generation unit 11a in detail.

The state information 83 and the predicted state information 81 include position information 801 that is information regarding the position of the predetermined portion of the task execution robot 2 and/or of each of the actuators 21. The state information 83 and the predicted state information 81 include force information 802 that is information regarding the force applied to the predetermined portion and/or each of the actuators 21. As described above, the predetermined portion is the end effector 22 or the like. The operation information 84 also includes the position information 801 and the force information 802. Each of the position and the force is the “state quantity” in the above-described “same type of state quantity”.

The task execution robot command information generation unit 11a (the command information generation unit 11) generates the task execution robot command information 82a (the command information 82) based on the position information 801 and the force information 802. Similarly, the operation unit command information generation unit 11b (the command information generation unit 11) generates the operation unit command information 82b (the command information 82) based on the position information 801 and the force information 802. In the command information 82, the task execution robot command information 82a is output to the task execution robot 2, and the operation unit command information 82b is output to the operation unit 5. Thus, the task execution robot 2 and the operation unit 5 can be operated.

### Control Method

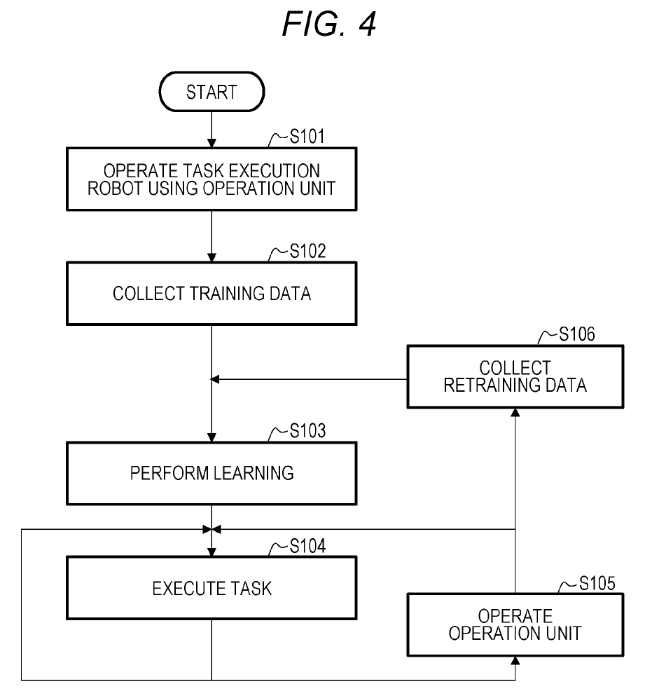

FIG. 4 is a flowchart illustrating a procedure of a control method of the robot system Z according to the first embodiment.

First, the user operates the task execution robot 2 using the operation unit 5 (S101).

The learning unit 4 collects training data 87 (see FIG. 9) (S102). The training data 87 is time-series data of the state information 83 of the task execution robot 2 and/or the operation information 84 of the operation unit 5 during the execution of a task.

Then, the learning unit 4 performs learning (S103). As a result of step S103, the trained model 41 is generated. The training data 87 to be used is what has been collected in step S102. The learning is performed based on the training data 87 which is the time-series data of the state information 83 of the task execution robot 2 and/or the operation information 84 of the operation unit 5 during the execution of the task.

Then, the control unit 1 causes the task execution robot 2 to autonomously operate and execute the task based on the generated trained model 41 (S104). Step S104 corresponds to a “state information acquisition step” and a “task execution robot command information generation step”.

Thereafter, when the user operates the operation unit 5 (S105), the task execution robot command information generation unit 11a corrects the task execution robot command information 82a based on the operation information 84 output from the operation unit 5. At this time, the state information 83 of the task execution robot 2 is input to the trained model 41, so that the predicted state information 81, which is the state information 83 of the task execution robot 2 at the next time, is output. The task execution robot 2 performs an autonomous operation based on the corrected task execution robot command information 82a, and executes the task.

Then, the learning unit 4 performs learning (relearning) based on the training data 87 collected in step S102 and the retraining data 85 collected in step S106 (S103). The retraining data 85 may be collected after the task is completed, or may be collected during execution of the task.

In conventional techniques, when the task execution robot 2 fails a task, the task of the task execution robot 2 is reset. Then, the user operates the task execution robot 2 from the beginning of the task to collect the retraining data 85. For example, it is assumed that there occurs a failure in which the task execution robot 2 tries to insert a workpiece in front of a pit while executing a task of inserting the workpiece into the pit provided on a horizontal plane. It is assumed that a position of the pit has been changed by a change of a design specification.

When such an event occurs, in the conventional techniques, the task of the task execution robot 2 is reset, and a state of the task execution robot 2 is returned to a task start state. Thereafter, the user operates the operation unit 5 to operate the task execution robot 2. In the above example, the user operates the operation unit 5 to operate the task execution robot 2 such that the workpiece is inserted into the pit. The state information 83 of the task execution robot 2 by this operation is used as the retraining data 85.

On the other hand, in the robot system Z described in the first embodiment, the state information 83 of the task execution robot 2 and/or the operation information 84 output from the task execution robot command information generation unit 11a is collected as the retraining data 85. Then, the learning unit 4 performs relearning with respect to the trained model 41 using the retraining data 85. For example, as in the above-described example, in a case where the task execution robot 2 tried to insert the workpiece in front of the pit or cannot insert the workpiece while trying to insert the workpiece in front of the pit, the user intervenes in the control of the task execution robot 2. The intervention is performed by adding the operation information 84 output from the operation unit 5 when the user operates the operation unit 5 to the current state information 83 of the task execution robot 2.

Specifically, the user operates the task execution robot 2 via the operation unit 5 from a point in time when the task execution robot 2 fails without resetting the task execution robot 2. As in the above-described example, when the task execution robot 2 tries to insert the workpiece in front of the pit, the user operates the task execution robot 2 such that the task execution robot 2 can insert the workpiece into the pit by moving the end effector 22 of the task execution robot 2 to the back side.

The state information 83 of the task execution robot 2 obtained by such an operation and the operation information 84 output from the operation unit 5 are used for learning (relearning) as the retraining data 85. Thus, when the workpiece cannot be inserted into the pit, the task execution robot 2 can autonomously perform an operation of moving the end effector 22 to the back side.

Since the operation as described above only corrects the operation of the task execution robot 2 (only moves the end effector 22 to the back side in the above-described example), an operation amount of the operation unit 5 by the user is small, and the time required for the correction is also short. Since an operation of the operation unit 5 is merely a correction operation, even the user (that is, a beginner) who is not accustomed to operating the task execution robot 2 via the operation unit 5 can easily perform the operation. As described above, the retraining data 85, which is retraining data, can be efficiently acquired according to the first embodiment.

In conventional methods, when the task execution robot 2 fails a task, an operation of the task execution robot 2 is reset, and a correction operation is performed from the beginning of the task as described above. Therefore, in the case of the above-described example, there is a possibility that the task execution robot 2 cannot cope with a position of the pit before the change of the design specification. Alternatively, processing of recognizing the position of the pit is required at the start of the task.

According to the present embodiment, the task execution robot 2 completes the task if the workpiece can be inserted into the pit. However, when the insertion into the pit is not possible, the workpiece can be inserted into the pit by moving the end effector 22 to the back side. As a result, it is possible to easily cope with two positions of the pit, that is, the positions before and after the change of the design specification.

Furthermore, as in the above-described example, when the task execution robot 2 continues the operation of inserting the workpiece in front of the pit, there is a possibility that a member provided with the pit is damaged or the task execution robot 2 is damaged. According to the present embodiment, such a situation can be avoided. Furthermore, even when the user operates the operation unit 5, the user can feel the reaction force through the operation unit 5, so that the damage to the member and the task execution robot 2 can be avoided.

As described above, the state information 83 based on the operation of the task execution robot 2 is input to the operation unit command information generation unit 11b. Thus, when the user operates the operation unit 5, the user can feel the reaction force generated in the task execution robot 2 or the like. Thus, the user can operate the task execution robot 2 by the operation unit 5 while relying on the sense. For example, when the task of inserting the workpiece into the pit provided in the horizontal plane is performed as described above, the user can determine that the workpiece has been inserted into the pit when the user no longer feels the reaction force via the operation unit 5.

### Second Embodiment

### Operation Detection by User

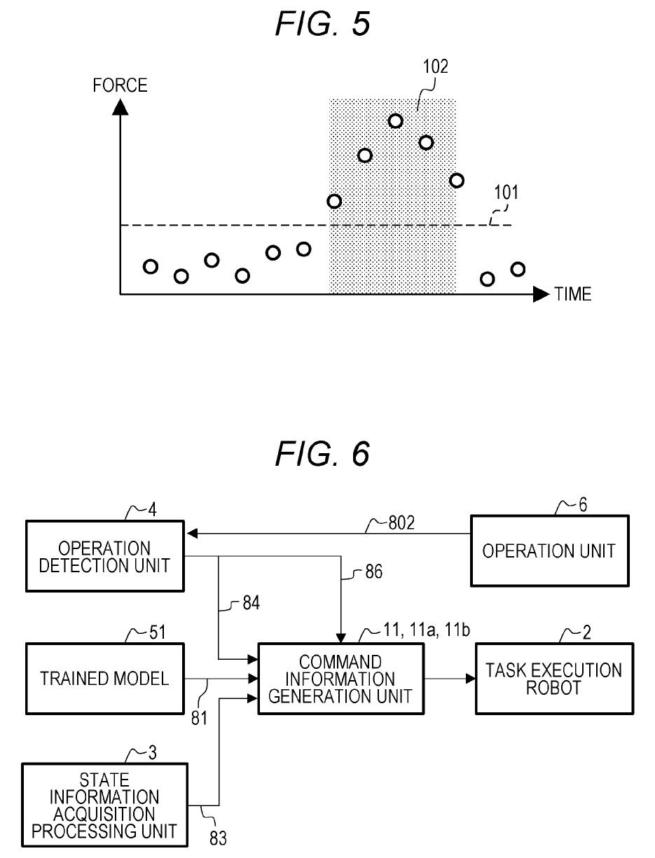

FIG. 5 is a view illustrating a method of operation detection by a user.

FIG. 5 is a view illustrating temporal changes of the force information 802 among pieces of information constituting the operation information 84, in which the vertical axis represents a force included in the force information 802, and the horizontal axis represents time. The force is a force applied to the actuator 21 of the operation unit 5 or the like.

Then, when the force exceeds a threshold 101, the operation detection unit 6 determines that an operation performed by a user has occurred. At this time, the operation detection unit 6 determines that the user's operation has occurred in a range 102 where the force exceeds the threshold 101.

As illustrated in FIG. 5, the operation detection unit 6 detects an operation by the operation unit 5 based on the operation information 84 (the force information 802 in the example illustrated in FIG. 5). In this manner, it is possible to perform control switching to be described later and to efficiently collect the retraining data 85.

### Control Switching

FIG. 6 is a diagram illustrating control switching accompanying the operation detection by the user.

The task execution robot command information generation unit 11a generates the task execution robot command information 82a based on the state information 83, the operation information 84, the predicted state information 81, and operation detection information 86. Note that the operation detection information 86 is information regarding whether an operation by the operation unit 5 has been performed.

Specifically, when no operation of the operation unit 5 is detected by the operation detection information 86, the task execution robot command information generation unit 11a generates the task execution robot command information 82a based on the state information 83 and the predicted state information 81. When the operation of the operation unit 5 is detected based on the operation detection information 86, the task execution robot command information generation unit 11a generates the task execution robot command information 82a based on the state information 83, the operation information 84, and the predicted state information 81.

As described above, when the operation detection unit 6 detects that the state quantity (the force in the force information 802) output from the operation unit 5 exceeds the threshold 101 illustrated in FIG. 5, the operation detection unit 6 outputs the operation information 84. The operation detection unit 6 also outputs the operation detection information 86 to the command information generation unit 11. The command information generation unit 11 includes the task execution robot command information generation unit 11a and the operation unit command information generation unit 11b.

The task execution robot command information generation unit 11a receiving the input of the operation detection information 86 generates new task execution robot command information 82a by adding the operation information 84 output from the operation detection unit 6 to the task execution robot command information 82a generated by itself. Then, the task execution robot command information generation unit 11a outputs the new task execution robot command information 82a to the task execution robot 2. Note that the position in the position information 801 may be used instead of the force.

When the operation detection unit 6 has not detected the user's operation on the operation unit 5, the operation detection information 86 is not output. In this case, the task execution robot command information generation unit 11a outputs the task execution robot command information 82a generated by itself to the task execution robot 2 as it is.

The operation unit command information generation unit 11b also generates the operation unit command information 82b based on the state information 83, the operation information 84, the predicted state information 81, and the operation detection information 86. Specifically, when no operation of the operation unit 5 is detected based on the operation detection information 86, the operation unit command information generation unit 11b generates the operation unit command information 82b based on the state information 83 and the predicted state information 81. Then, when the operation of the operation unit 5 is detected by the operation detection information 86, the operation unit command information generation unit 11b generates the operation unit command information 82b based on the state information 83, the operation information 84, and the predicted state information 81.

By performing the above control switching, the task execution robot 2 can perform an operation in which the user's operation using the operation unit 5 intervenes and an operation without the intervention separately.

### Control Method

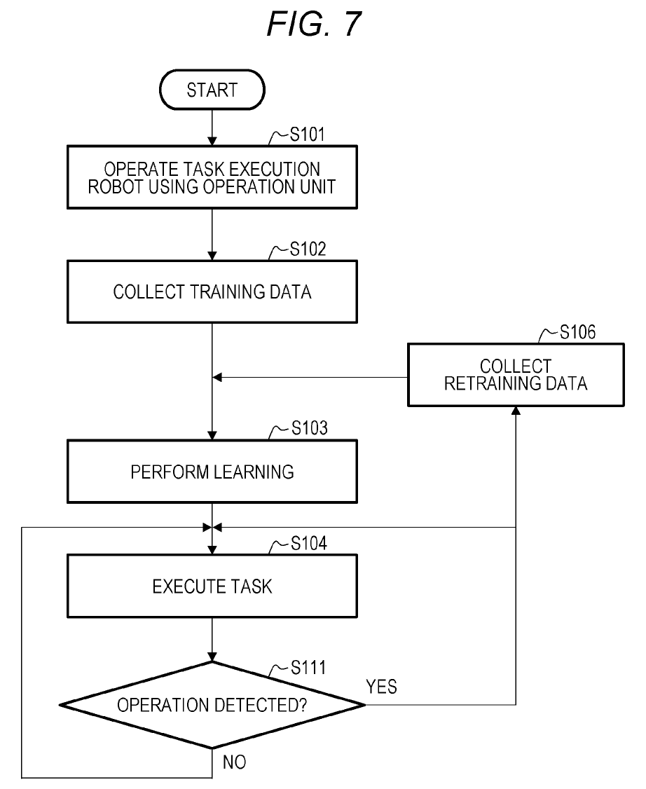

FIG. 7 is a flowchart illustrating a procedure of a control method of the robot system Z according to the second embodiment. In FIG. 7, processes similar to those in FIG. 4 are denoted by the same step numbers, and the description thereof will be omitted.

FIG. 7 differs from FIG. 4 in that a process of determining whether the operation detection unit 6 detects the user's operation on the operation unit 5 is performed.

That is, after step S104, the operation detection unit 6 determines whether the user's operation on the operation unit 5 is detected during execution of a task (S111).

When the operation is not detected (S111 → No), the control unit 1 returns the processing to step S104 and continues to execute the task.

When the operation is detected (Yes in S111), the learning unit 4 collects the retraining data 85 (S106). The retraining data 85 is the state information 83 of the task execution robot 2 when the user has performed the operation and the operation information 84 output from the operation unit 5. In the processing illustrated in FIG. 7, the collection of the retraining data 85 is desirably performed after the task is completed.

The state information 83 of the task execution robot 2 is input to the trained model 41, so that the predicted state information 81, which is the state information 83 of the task execution robot 2 at the next time, is output. In this manner, the task execution robot 2 can operate based on the trained model 41.

### Third Embodiment

### Retraining Data 85

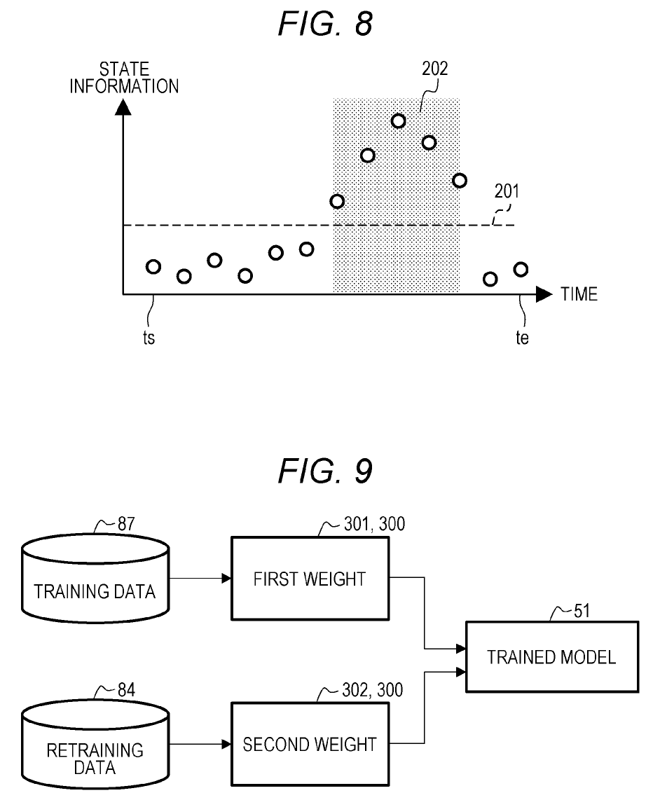

FIG. 8 is a view related to the state information 83 collected as the retraining data 85.

FIG. 8 is a view illustrating temporal changes of a state quantity included in the state information 83 output from the state information acquisition processing unit 3. In FIG. 8, the vertical axis represents the state quantity, and the horizontal axis represents time. The state quantity represents a position of the position information 801 constituting the state information 83 and an amount of a force of the force information 802. FIG. 8 may be a view related to the operation information 84. FIG. 8 is obtained by changing the vertical axis (force) in FIG. 5 to “state information”.

First, the operation detection unit 6 detects an operation by the operation unit 5 based on the state information 83 or the operation information 84. Specifically, when the state quantity in the state information 83 or the operation information 84 exceeds a threshold 201, an operation of the task execution robot 2 is detected. Then, the learning unit 4 acquires the state information 83 and/or the operation information 84 included in a range 202 from the start to the end of a task as the retraining data 85. The start of the task is a start time “ts” illustrated in FIG. 8, and the end of the task is an end time “te”.

As described above, when the operation by the operation unit 5 is detected, the state information 83 and the operation information 84 in the range 202 from the start time “ts” to the end time “te” of the task are acquired, so that the retraining data 85 can be efficiently collected.

### Fourth Embodiment

### Weighting

FIG. 9 is a diagram related to weighting of the training data 87 and the retraining data 85.

As illustrated in FIG. 9, the learning unit 4 performs relearning using the training data 87 and the retraining data 85. As a result of the relearning, the already existing trained model 41 is updated. Then, a weighting factor 300 (a first weight 301 and a second weight 302) for learning is set for each of the training data 87 and the retraining data 85.

The learning unit 4 weights each of the training data 87 and the retraining data 85 (the first weight 301 and the second weight 302), then performs learning (relearning), and updates the trained model 41. In a case where a neural network is used for learning, the weighting factor 300 represents a weight between respective neurons. That is, in a case where the first weight 301 is made larger than the second weight 302, when the training data 87 is input, the weight between neurons is set such that an output is larger than an output when the retraining data 85 is input.

With such a configuration, it is possible to give priority to an operation with respect to the task execution robot 2 based on the training data 87 and the retraining data 85. For example, when the first weight 301 is set to be larger than the second weight 302, the task execution robot 2 preferentially performs an operation based on the training data 87. That is, the task execution robot 2 first performs the operation based on the training data 87, and, when a task cannot be completed by this operation, the task execution robot 2 becomes possible to perform an operation based on the retraining data 85.

Note that the first weight 301 and the second weight 302 may be priorities. Setting the priority does not mean adjusting the weight between neurons in the neural network described above, but means setting the priority to an output to the task execution robot 2 by the control unit 1. That is, the control unit 1 first causes the task execution robot 2 to perform the operation based on the training data 87. When the task fails, the control unit 1 causes the task execution robot 2 to perform the operation based on the retraining data 85.

In this manner, the control unit 1 causes the task execution robot 2 to preferentially perform the operation based on the training data 87. When the operation is not successfully completed with the operation based on the training data 87, the control unit 1 causes the task execution robot 2 to execute the operation based on the retraining data 85.

### Robot System Za

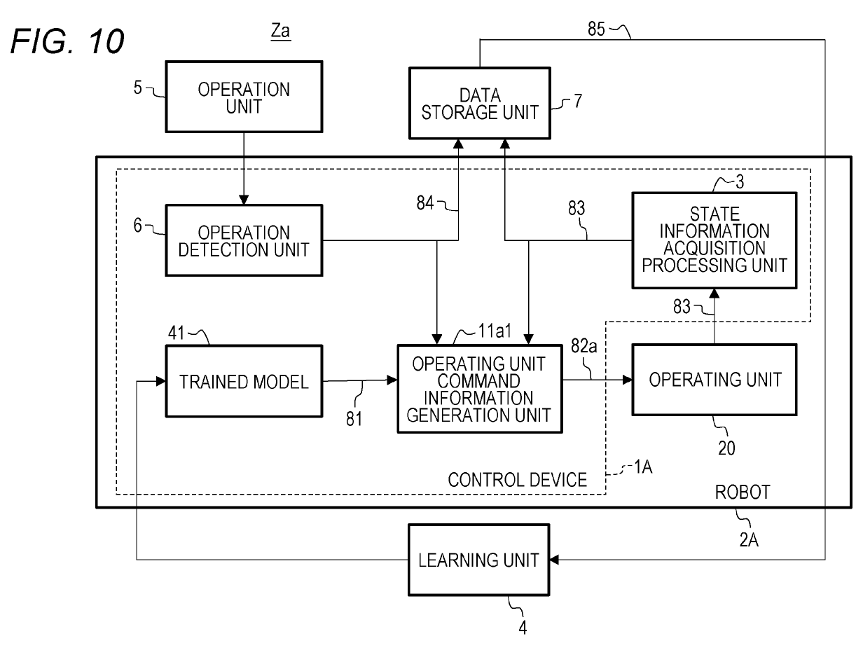

FIG. 10 is a diagram illustrating a configuration of a robot system Za that is a modification of the robot system Z illustrated in FIG. 1.

Configurations similar to those in FIG. 1 will be denoted by the same reference signs in FIG. 10, and the description thereof will be omitted.

The robot system Za illustrated in FIG. 10 includes a robot 2A, the learning unit 4, the operation unit 5, and the data storage unit 7. The robot 2A includes a control device 1A and an operating unit 20. The control device 1A controls an operation of the operating unit 20 that autonomously executes a task. The operating unit 20 is the end effector 22, the actuator 21, or the like illustrated in FIG. 2.

The control device 1A includes an operating unit command information generation unit 11a1, the state information acquisition processing unit 3, the operation detection unit 6, and the operating unit 20. The operating unit command information generation unit 11a1 performs processing similar to that of the task execution robot command information generation unit 11a. The control device 1A may include the operation unit command information generation unit 11b illustrated in FIG. 2.

### Hardware Configuration Diagram

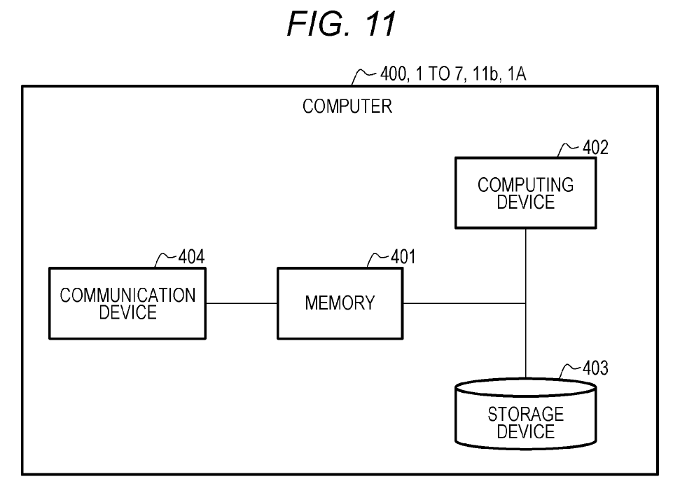

FIG. 11 is a diagram illustrating a hardware configuration of a computer 400.

The computer 400 corresponds to the control unit 1 to the data storage unit 7 illustrated in FIG. 1, the operation unit command information generation unit 11b illustrated in FIG. 2, and the control device 1A illustrated in FIG. 10.

The computer 400 includes a memory 401, a computing device 402, a storage device 403, and a communication device 404.

The memory 401 includes a random access memory (RAM), a read only memory (ROM), or the like. The computing device 402 includes a central processing unit (CPU), a graphic processing unit (GPU), or the like. The storage device 403 includes a hard disc drive (HDD), a solid state drive (SSD), or the like. In a case where the memory 401 includes a ROM, the storage device 403 can be omitted. The communication device 404 communicates with other devices.

Then, a program stored in the storage device 403 is loaded, and the loaded program is executed by the computing device 402. Alternatively, in a case where the memory 401 includes a ROM, a program stored in the memory 401 is executed by the computing device 402. Thus, functions of the control unit 1 to the data storage unit 7, the operation unit command information generation unit 11b, and the control device 1A illustrated in FIG. 10 are implemented.

In the present embodiment, the operation unit 5 is assumed to be a robot having a format similar to that of the task execution robot 2. However, if the user does not need to recognize the reaction force detected by the task execution robot 2, a controller can be used as the operation unit 5.

The present invention is not limited to the above-described embodiments, and includes various modifications. For example, the above-described embodiments have been described in detail in order to describe the present invention in an easily understandable manner, and are not necessarily limited to one including the entire configuration that has been described above. Further, configurations of another embodiment can be substituted for some configurations of a certain embodiment, and a configuration of another embodiment can be added to a configuration of a certain embodiment. Further, addition, deletion or substitution of other configurations can be made with respect to some configurations of each embodiment.

Further, some or all of the above-described configurations, functions, the control unit 1 to the data storage unit 7, the task execution robot command information generation unit 11a, the operation unit command information generation unit 11b, the storage device 403, and the like may be implemented by hardware, for example, by being designed using an integrated circuit or the like. Further, the above-described respective configurations, functions and the like may be implemented by software by causing a processor, such as a CPU, to interpret and execute a program for implementing the respective functions as illustrated in FIG. 11. Information such as a program, a table, and a file that implements each function can be stored in not only a hard disk (HD) but also a recording device such as the memory 401 and a solid state drive (SSD) or a recording medium such as an integrated circuit (IC) card, a secure digital (SD) memory card, a digital versatile disc (DVD).

Further, control lines and information lines considered to be necessary for the description have been illustrated in the respective embodiments, and it is difficult to say that all of the control lines and information lines required as a product are illustrated. It may be considered that most of configurations are practically connected to each other.

What is claimed is:

1. A robot system comprising:
a task execution robot configured to autonomously execute a task according to predicted state information based on a trained model;
a state information acquisition processing unit configured to acquire state information of the task execution robot;
an operation unit configured to output operation information for causing the task execution robot to operate;
a control unit configured to control the task execution robot; and
a learning unit configured to perform learning based on the state information of the task execution robot and/or the operation information to generate the trained model,
wherein the control unit includes a task execution robot command information generation unit configured to generate task execution robot command information, which is command information for the task execution robot, based on the state information, the operation information, and the predicted state information, and
the learning unit collects the state information of the task execution robot and/or the operation information output from the task execution robot command information generation unit as retraining data, and performs relearning with respect to the trained model using the retraining data.

2. The robot system according to claim 1, wherein
the operation information is information including a same type of state quantity as a state quantity included in the state information, and
the control unit includes an operation unit command information generation unit configured to generate operation unit command information, which is command information for the operation unit, based on the state information, the operation information, and the predicted state information.

3. The robot system according to claim 2, wherein the operation unit includes actuators as many as actuators of the task execution robot.

4. The robot system according to claim 3, wherein
the state information and the predicted state information include position information, which is information regarding a position of a predetermined portion in the task execution robot and/or each of the actuators, and include force information which is information regarding a force applied to the predetermined portion and/or each of the actuators,
the task execution robot command information generation unit generates the task execution robot command information based on the position information and the force information, and
the operation unit command information generation unit generates the operation unit command information based on the position information and the force information.

5. The robot system according to claim 4, further comprising an operation detection unit configured to detect an operation by the operation unit based on the operation information.

6. The robot system according to claim 5, wherein the task execution robot command information generation unit generates the task execution robot command information based on the state information, the operation information, the predicted state information, and operation detection information that is output from the operation detection unit and is information regarding whether an operation has been performed.

7. The robot system according to claim 6, wherein
the task execution robot command information generation unit
generates the task execution robot command information based on the state information and the predicted state information when the operation of the operation unit is not detected based on the operation detection information, and
generates the task execution robot command information based on the state information, the operation information, and the predicted state information when the operation of the operation unit is detected based on the operation detection information.

8. The robot system according to claim 1, wherein
the trained model is trained based on training data that is time-series data of the state information of the task execution robot and/or the operation information of the operation unit during the execution of the task, and
the predicted state information that is state information of the task execution robot at a next time is output when the state information of the task execution robot is input to the trained model.

9. The robot system according to claim 1, further comprising an operation detection unit configured to detect an operation performed by the operation unit based on the state information or the operation information,
wherein the learning unit acquires the state information and/or the operation information included in a range from a start to an end of the task as the retraining data.

10. The robot system according to claim 8, wherein
the learning unit performs the relearning using the training data and the retraining data, and
a weighting factor for the learning is set for each of the training data and the retraining data.

11. A control device comprising:
a state information acquisition processing unit configured to acquire state information of an operating unit autonomously executing a task according to predicted state information based on a trained model; and
a task execution robot command information generation unit configured to generate task execution robot command information, which is command information for the operating unit, based on the state information, operation information output from an operation unit, and the predicted state information,
wherein the trained model is updated by collecting the state information of the operating unit output from the task execution robot command information generation unit and/or the operation information as retraining data, and performing relearning with respect to the trained model using the retraining data.

12. A robot comprising the control device according to claim 11.

13. A control method performed by a control device configured to control an operation of an operating unit autonomously executing a task, the control method comprising:
a state information acquisition processing step of acquiring state information of the operating unit according to predicted state information based on a trained model; and
a task execution robot command information generation step of generating task execution robot command information, which is command information for the operating unit, based on the state information, operation information output from an operation unit, and the predicted state information,
wherein the trained model is updated by collecting the state information of the operating unit output in the task execution robot command information generation step and/or the operation information as retraining data, and performing relearning with respect to the trained model using the retraining data.
